(19) United States
(12) Patent Application Publication
(10) Pub. No.: US 2013/0334290 A1
(43) Pub. Date: Dec. 19, 2013

(54) SOLDER PASTE DROPLET EJECTION APPARATUS, PATTERNING SYSTEM HAVING THE SAME, AND CONTROL METHOD THEREOF

(71) Applicants: Young Ju LEE, Gyunggi-do (KR); Yun Bog KIM, Gyunggi-do (KR); Seon Young MYOUNG, Gyunggi-do (KR); Suk Jin HAM, Gyunngi-do (KR); Seong Chan PARK, Gyunggi-do (KR); Hyun Jung LEE, Gyunggi-do (KR)

(72) Inventors: Young Ju LEE, Gyunggi-do (KR); Yun Bog KIM, Gyunggi-do (KR); Seon Young MYOUNG, Gyunggi-do (KR); Suk Jin HAM, Gyunngi-do (KR); Seong Chan PARK, Gyunggi-do (KR); Hyun Jung LEE, Gyunggi-do (KR)

(73) Assignee: SAMSUNG ELECTRO-MECHANICS CO., LTD., Gyunggi-do (KR)

(21) Appl. No.: 13/592,051

(22) Filed: Aug. 22, 2012

(30) Foreign Application Priority Data
Jun. 18, 2012 (KR) 10-2012-0065049

(51) Int. Cl. B23K 3/053; B23K 1/00

(52) U.S. Cl. 228/102; 228/33

(57) ABSTRACT

Disclosed herein is a solder paste droplet ejection apparatus including: a nozzle cap forming an appearance and including a heating electric wire provided inside thereof; a nozzle unit formed inside the nozzle cap, spaced apart from the nozzle cap, and surrounded by the nozzle cap; an ejection probe formed inside the nozzle unit, spaced apart from the nozzle unit, and surrounded by the nozzle unit; and a transfer unit formed in a top portion of the nozzle cap and used for a minute movement, wherein a solder paste supplied in a space between the nozzle unit and the ejection probe is ejected in a droplet shape along the ejection probe.

### CROSS REFERENCE TO RELATED APPLICATION

This application claims the benefit of Korean Patent Application No. 10-2012-0065049, filed on Jun. 18, 2012, entitled “Solder-Paste Droplet Ejection Apparatus, Patterning System Having the Same, and Control Method Thereof”, which is hereby incorporated by reference in its entirety into this application.

### BACKGROUND OF THE INVENTION

1. Technical Field

The present invention relates to a solder paste droplet ejection apparatus, patterning system having the same, and control method thereof.

2. Description of the Related Art

A solder paste is a core material used to form a solder bump for mounting a device onto a PCB. In general, examples of methods of forming the solder bump are an electroplating method, an inkjet method, a screen printing method, etc.

Among these methods, the inkjet method is a widely used method in MEMS, a semiconductor process, etc., in addition to a printer, and, in particular, plays a very important role in an operation of forming a bump during a circuit patterning and electronic packaging process using metal ink.

However, in order to meet demands of high density, small-sized, and high performance electronic devices, in particular, a nano-patterning method capable of dramatically reducing a nano-patterning operation, and controlling a bump size and a pitch interval minutely at a nano-level is needed.

The conventional nano-patterning technologies that meet such demands are a dip-pen using method and a nano-inkjet method disclosed in Korean Patent Laid-Open Publication No. 2010-0043542 (laid-open published on Apr. 29, 2010).

However, these methods are not suitable for forming a pattern of a uniform size such as a solder ball.

That is, since the dip-pen using method performs patterning by supplying ink to a tip, a continuous process is impossible, which is problematic in the mass production, and the ink-jet method enables nano-level patterning, whereas it takes long time to perform the ink-jet method.

### SUMMARY OF THE INVENTION

The present invention has been made in an effort to provide a solder paste droplet ejection apparatus capable of performing a patterning process by continuously ejecting solder paste droplets.

Further, the present invention has been made in an effort to provide a patterning system including a solder paste droplet ejection apparatus capable of performing a patterning process by continuously ejecting solder paste droplets.

Further, the present invention has been made in an effort to provide a patterning control method capable of performing a patterning process by continuously ejecting solder paste droplets.

According to one preferred embodiment of the present invention, there is provided a solder paste droplet ejection apparatus, including: a nozzle cap forming an appearance and including a heating electric wire provided inside thereof; a nozzle unit formed inside the nozzle cap, spaced apart from the nozzle cap, and surrounded by the nozzle cap; an ejection probe formed inside the nozzle unit, spaced apart from the nozzle unit, and surrounded by the nozzle unit; and a transfer unit formed at a top portion of the nozzle cap and used for a minute movement, wherein a solder paste supplied in a space between the nozzle unit and the ejection probe is ejected in a droplet shape along the ejection probe.

The nozzle cap may be formed in a tube shape having a width narrower in a lower direction, and form a gas path that sprays an inert gas injected between the nozzle cap and the nozzle unit in a direction of an end portion.

The ejection probe may be formed in a shape of a sharp needle in a direction of an end portion by using a metallic material, and be configured to protrude from an end portion through hole of the nozzle cap.

The nozzle unit may include a temperature detector for detecting a temperature of the solder paste inside thereof.

The transfer unit may include a piezo-actuator or a motor.

According to another preferred embodiment of the present invention, there is provided a patterning system including: a stage holding a target and having an electric polarity; a solder paste droplet ejection apparatus ejecting a solder paste to the target in a droplet shape; a pressurizing unit supplying the solder paste from a storage unit of the solder paste to the solder paste droplet ejection apparatus; a control unit performing a control on an ejection of the solder paste droplet; a gas pumping unit connected to the control unit and supplying an inert gas to the solder paste droplet ejection apparatus; and a display unit connected to the control unit and displaying control information on a nano-patterning operation using the solder paste droplet.

The stage may be connected to the control unit and have an electric polarity opposite to an electric polarity of the solder pasted droplet ejection apparatus.

The solder pasted droplet ejection apparatus may include: a nozzle cap forming an appearance and including a heating electric wire provided inside thereof; a nozzle unit formed inside the nozzle cap, spaced apart from the nozzle cap, and surrounded by the nozzle cap; an ejection probe formed inside the nozzle unit, spaced apart from the nozzle unit, and surrounded by the nozzle unit; and a transfer unit formed in a top portion of the nozzle cap and used for a minute movement, wherein a solder paste supplied in a space between the nozzle unit and the ejection probe is heated by the heating electric wire and is ejected in a droplet shape along the ejection probe by the pressurizing unit

The control unit may control a voltage applied to the ejection probe and control a size of the solder paste droplet.

The control unit may adjust a pulse width of the voltage and applies the voltage.

The nozzle cap may be formed in a tube shape having a width narrower in a lower direction, and form a gas path that sprays an inert gas that is supplied from the gas pumping unit and is injected between the nozzle cap and the nozzle unit in a direction of an end portion.

The ejection probe may be formed in a shape of a sharp needle in a direction of an end portion by using a metallic material, and be configured to protrude from an end portion through hole of the nozzle cap.

The nozzle unit may include a temperature detector for detecting a temperature of the solder paste inside thereof.

According to another preferred embodiment of the present invention, there is provided a patterning control method including: preheating, by a control unit, a solder paste supplied to a solder paste droplet ejection apparatus to change the solder paste into a melting state; ejecting, by the control unit, the melted solder paste onto a target in a minute droplet shape by using a voltage applied to the solder paste droplet ejection apparatus or an inert gas; determining, by the control unit, whether a size of a pattern formed in the target by the ejected minute droplet is a desired size; and according to a determination result that the size of the pattern is not the desired size, ejecting, by the control unit, the solder paste in the minute droplet shape again based on ejection conditions corrected on the solder paste droplet ejection apparatus.

In the preheating, the control unit may apply a voltage to a heating electric wire included in a nozzle cap forming an appearance of the solder paste droplet ejection apparatus to change the solder paste contained in the solder paste droplet ejection apparatus into the melting state.

In the preheating, the control unit may apply electric polarities to a stage holding the target and the solder paste droplet ejection apparatus to generate an electrostatic force between the target and the solder paste droplet ejection apparatus.

In the ejecting of the melted solder paste onto the target in the minute droplet shape, the control unit may set an ejection application voltage applied to an ejection probe of the solder paste droplet ejection apparatus, a pulse waveform of the ejection application voltage, and a distance between the ejection probe and the target to eject the melted solder paste in the minute droplet shape.

The ejection application voltage V may be applied as a numerical value having a range of

$$h \sqrt{\frac{γ π}{{ɛ}_{0} d}} > V > \sqrt{\frac{γ kd}{2 {ɛ}_{0}}}$$

(γ: surface tension [N/m] of melted solder paste, ε₀: dielectric permittivity [F/m] of vacuum, d: diameter of a sharp end portion of an ejection probe, h: distance between the ejection probe and a target, k: proportional constant).

In the ejecting of the melted solder paste onto the target in the minute droplet shape, the minute droplet that is being formed may be ejected by using a spray pressure of the inert gas injected into the solder paste droplet ejection apparatus.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a schematic view of a construction of a patterning system including a solder paste droplet ejection apparatus according to an embodiment of the present invention;

FIG. 2A is an exemplary view for explaining an operation principle of a solder paste droplet ejection apparatus according to an embodiment of the present invention;

FIG. 2B is a cross-sectional view of a nozzle unit of a solder paste droplet ejection apparatus according to an embodiment of the present invention;

FIG. 3 is a bottom view of a nozzle cap of a solder paste droplet ejection apparatus according to an embodiment of the present invention; and

FIG. 4 is a flowchart of a patterning control method of performing a patterning process by ejecting a solder paste according to another embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the accompanying drawings.

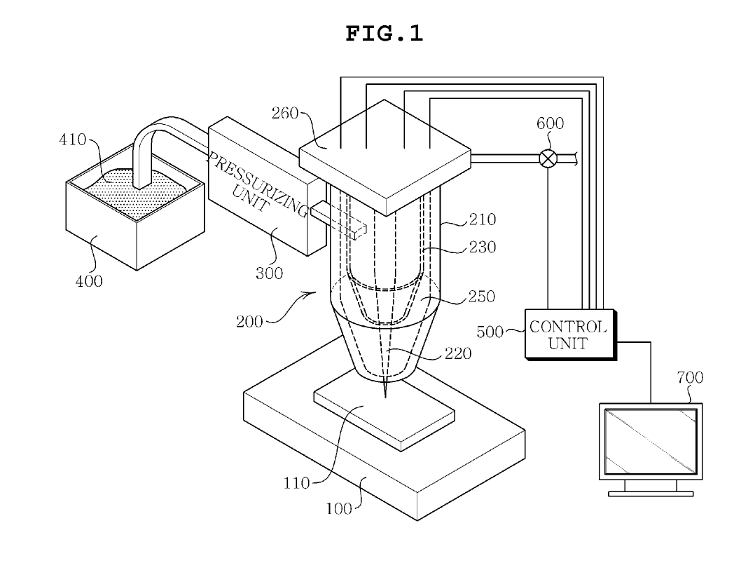

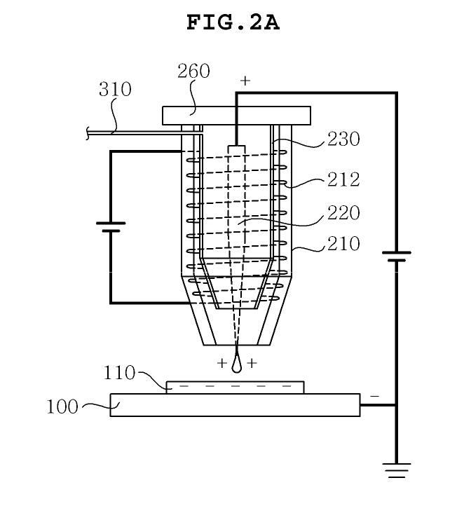

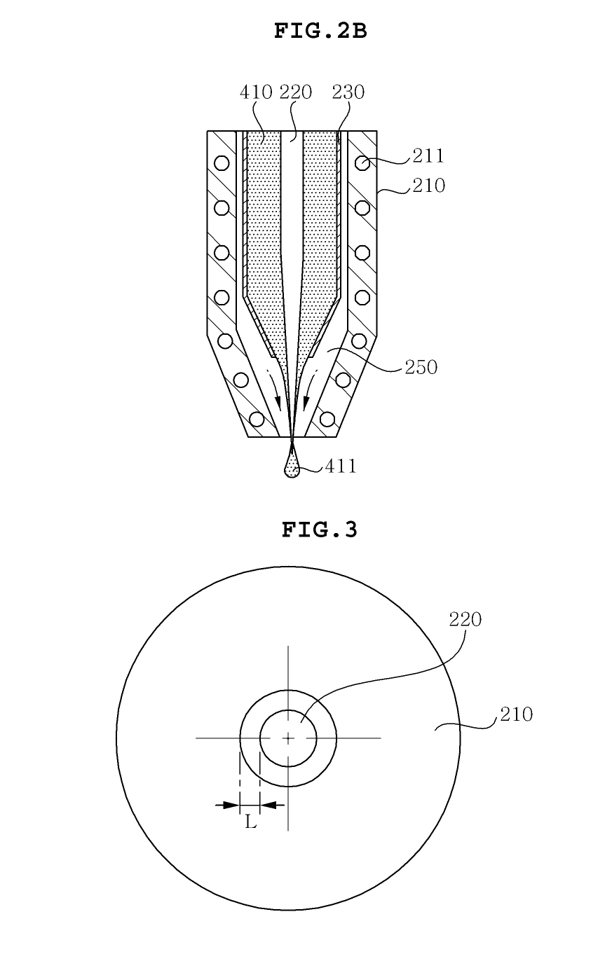

FIG. 1 is a schematic view of a construction of a patterning system including a solder paste droplet ejection apparatus according to an embodiment of the present invention. FIG. 2A is an exemplary view for explaining an operation principle of a solder paste droplet ejection apparatus according to an embodiment of the present invention. FIG. 2B is a cross-sectional view of a nozzle unit of a solder paste droplet ejection apparatus according to an embodiment of the present invention. FIG. 3 is a bottom view of a nozzle cap of a solder paste droplet ejection apparatus according to an embodiment of the present invention. In this regard, although the patterning system according to an embodiment of the present invention exemplarily patterns a solder paste on a target such as a printed circuit board by a solder bump, the present invention is not limited thereto. A variety of patterns including a nano-level conductive pattern may be formed on a substrate by using a conductive paste.

Referring to FIG. 1, the patterning system according to an embodiment of the present invention includes a stage 100 that holds a target 110 such as a printed circuit board and has an electrical polarity, a solder paste droplet ejection apparatus 200, a pressurizing unit 300 that supplies a solder paste 410 to the solder paste droplet ejection apparatus 200 from a storage unit 400, a control unit 500 that performs a general control on ejection of the solder paste 410, a gas pumping unit 600 that is connected to the control unit 500 and supplies an inert gas to the solder paste droplet ejection apparatus 200, and a display unit 700 that is connected to the control unit 500 and displays control information of a nano-patterning operation.

The solder paste droplet ejection apparatus 200 may form the solder paste 410 of the storage unit 400 supplied by the pressurizing unit 300 in minute droplets at an end portion of an ejection probe 220 by an electrostatic force according to a control of the control unit 500. The formed minute droplets of the solder paste 410 may be ejected onto the target 110 by the electrostatic force or the inert gas.

More specifically, the solder paste droplet ejection apparatus 200 may include a nozzle cap 210 forming an appearance and in which a heating electric wire 212 is coiled inside, a nozzle unit 230 spaced toward the inside of the nozzle cap 210 so as to form a gas path 250 inside the nozzle cap 210, an ejection probe 220 surrounded by the nozzle unit 230, and a transfer unit 260 formed in an upper portion used for a minute movement.

As shown in FIG. 2A, the nozzle cap 210 has a cylindrical exterior shape, is spaced apart from and surrounds the nozzle unit 230, and is in a tube shape having a width narrower in a direction of the end portion. The gas path 250 is formed between the nozzle cap 210 and the nozzle unit 230. Also, the nozzle cap 210 includes the heating electric wire 212 by forming through holes 211 to the end portion along an inner portion of the boundary. The heating electric wire 212 may be included in the through holes 211 so that the nozzle cap 210 may perform a heating function by electric heating of the heating electric wire 212.

Accordingly, the nozzle cap 210 may be formed of a material of heat resistance that is not modified by a high temperature and to which the solder paste 410 is not bonded well, for example, a metal material such as AL, stainless steel, a ceramic material, or a polymer material such as plastic.

The nozzle cap 210 may heat the solder paste 410 contained in the nozzle unit 230 by a heating function and change the solder paste 410 into a melting state.

The nozzle unit 230 surrounds the ejection probe 220, places the solder paste 410 supplied by the pressurizing unit 300 in a space between the nozzle unit 230 and the ejection probe 220, and induces the solder paste 410 in a direction of an end portion of the ejection probe 220. In this regard, the solder paste 410 placed in the space between the nozzle unit 230 and the ejection probe 220 may smoothly flow in the direction of the end portion of the ejection probe 220 in the melting state by the heating function of the nozzle cap 210.

Also, the nozzle unit 230 may include a temperature detector such as a platinum resistance thermometer, a thermocouple, an infrared thermometer, etc. in order to detect a melting temperature of the solder paste.

The ejection probe 220 is formed of a metal material and has a sharp needle shape inside the nozzle unit 230. The ejection probe 220 having the above structure may be configured to protrude from a leading portion through hole of the nozzle cap 210 through an end portion through hole of the nozzle unit 230.

As shown in FIG. 2A, an electric field is formed by applying a polarity opposite to a polarity of the stage 100 to the ejection probe 220, and the melted solder paste 410 flows out along a surface of the ejection probe 220 by the electric field, so that the solder paste 410 forms a minute droplet 411 having charges at a leading portion of the ejection probe 220 as shown in FIG. 2B.

In this regard, to minimize evaporation of the minute droplet 411, evaporation of the solder paste 410 that flows out along the surface of the ejection probe 220 may be minimized by minimizing a spaced gap L between the ejection probe 220 and the nozzle cap 210 shown in FIG. 3.

The minute droplet 411 is ejected onto the target 110 by a voltage applied to the ejection probe 220 or the inert gas sprayed through the gas path 250.

In this regard, if the end portion of the ejection probe 220 is reduced in a sub-micro unit or a nano unit, an intensity of an electric field increases by the electrostatic force and thus the minute droplet 411 is easily ejected.

Also, the minute droplet 411 may obtain an ejection straightness of a stable track to the target 110 by the electrostatic force formed between the ejection probe 220 and the target 110, thereby increasing precision of an impact location of the ejected minute droplet 411.

Therefore, the ejection probe 220 may be used to form the minute droplet 411 and stably eject the minute droplet 411, and thus a bump having a minute size necessary for a packaging process is formed, and a pitch interval is minutely controlled.

The transfer unit 260 may be connected to the control unit 500 include a piezo-actuator or motor moves to X-Y-Z axes, and may preferably use a piezo-actuator capable of a minute control of a movement length.

The control unit 500 may be connected to the elements of the patterning system to generally control the nano patterning operation, in particular, form the minute droplet 411 of the solder paste 410 by using the solder paste droplet ejection apparatus 200, and control an operation of ejecting the minute droplet 411 of a set size to the target 110.

The above-described patterning system according to an embodiment of the present invention may maintain the viscosity solder paste 410 higher than a melting temperature by the nozzle cap 210 surrounding the nozzle unit 230 when the minute droplet 411 of the solder paste 410 is ejected from the nozzle unit 230 through the ejection probe 220, and prevent a temperature reduction of the solder paste 410 and an ejection block of the nozzle unit 230 by minimizing a room temperature standby contact surface of the ejection probe 220.

Also, the patterning system according to an embodiment of the present invention may prevent a composition of the solder paste 410 from changing due to generation of a gas, evaporation thereof, oxidation thereof by heating by injecting and spraying the inert gas such as nitrogen, argon, etc., into the gas path 250 formed between the nozzle cap 210a and the nozzle unit 230 through the gas pumping unit 600.

Further, the patterning system according to an embodiment of the present invention may minimize evaporation of the solder paste 410 that flows down along the surface of the ejection probe 220 by minimizing the spaced gap distance between the ejection probe 220 and the nozzle cap 210.

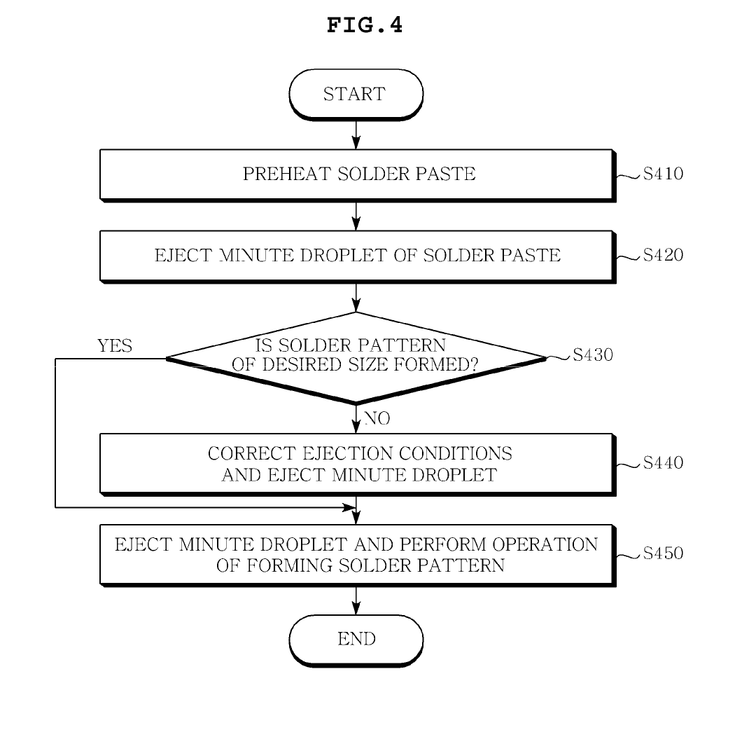

Hereinafter, a patterning control method capable of ejecting the solder paste 410 and performing a patterning operation according to another embodiment of the present invention will now be described with reference to FIG. 4. FIG. 4 is a flowchart of a patterning control method of performing a patterning process by ejecting a solder paste according to another embodiment of the present invention.

The patterning control method according to another embodiment of the present invention performs a preheating operation to change the solder paste 410 to a melting state (S410).

More specifically, the control unit 500 may preheat the solder paste 410 contained between the ejection probe 220 and the nozzle unit 230 to the melting state by applying a voltage to the heating electric wire 212 included in the nozzle cap 210.

In this regard, the control unit 500 may generate an electrostatic force between the target 110 and the ejection probe 220 by applying electric polarities to the stage 100 holding the target 110 such as a printed circuit board and the ejection probe 220.

Accordingly, the minute droplet 411 of the solder paste 410 formed in an end portion of the ejection probe 220 has charges, and the control unit 500 ejects the minute droplet 411 to the target 110 by using a voltage (hereinafter referred to as an “ejection application voltage V”) applied to the ejection probe 220 or an inert gas injected into the gas path 250 (S420).

More specifically, the ejection application voltage V applied to the ejection probe 220 is controlled and applied according to Equation 1 below.

$$h \sqrt{\frac{γ π}{{ɛ}_{0} d}} > V > \sqrt{\frac{γ kd}{2 {ɛ}_{0}}} \qquad [ Equation 1 ]$$

(γ: surface tension [N/m] of melted solder paste, ε₀: dielectric permittivity [F/m] of vacuum, d: diameter of a sharp end portion of an ejection probe, h: distance between the ejection probe and a target, k: proportional constant)

In Equation 1 above, a left term indicates a lowest ejection voltage in a case where a droplet is generally ejected by using an electric field between electrodes, and a right term indicates a lowest ejection voltage according to another embodiment of the present invention.

In consideration of an effect that the electric field focuses on the sharp end portion of the ejection probe 220, in Equation 1 above, as the diameter d of the sharp end portion of the ejection probe 220 is reduced, the ejection application voltage V is reduced in proportional to the diameter d, and thus the minute droplet 411 may be ejected at the low ejection application voltage V.

Also, since a size of the minute droplet 411 may be controlled by a pulse width of an ejection voltage, if a voltage of a single pulse waveform is applied to the ejection probe 220 at a time interval during an operation of forming the minute droplet 411, the size of the minute droplet 411 that is being formed may be minutely adjusted and the minute droplet 411 may be ejected.

Alternatively, the minute droplet 411 that is being formed may be ejected by using a spray pressure of the inert gas injected into the gas path 250.

After the minute droplet 411 is ejected onto the target 110, it is determined whether a size of a solder pattern formed in the target 110 by the ejected minute droplet 411 is a desired size (S430).

For example, to determine whether the size of the solder pattern is the desired size, the control unit 500 may analyze image information of the solder pattern formed in the target 110 by using a separately connected imaging apparatus (not shown) to determine whether the size of the solder pattern is the desired size of a nano unit.

If it is determined that the size of the solder pattern is not the desired size, the control unit 500 corrects ejection conditions based on Equation 1 above to eject the minute droplet 411 for forming the solder pattern of the desired size (S440).

That is, the control unit 500 may correct the ejection conditions including the ejection application voltage V applied to the ejection probe 220, the distance h between the ejection probe 220 and the target 110, the single pulse waveform of the ejection application voltage, etc. to eject the minute droplet 411 for forming the solder pattern of the desired size.

In particular, the control unit 500 adjusts a time interval in the single pulse waveform of the ejection application voltage to minutely adjust the size of the minute droplet 411, thereby forming the solder pattern of the desired size.

As the minute droplet 411 is ejected to form the solder pattern of the desired size, the control unit 500 continues to eject the minute droplet 411 and performs the operation of forming the solder pattern including a solder bump, etc. while minutely moving the solder paste droplet ejection apparatus 200 through the transfer unit 260 (S450).

Accordingly, the patterning control method according to another embodiment of the present invention may easily form the solder pattern including a minute solder bump, etc. in a sub-micro unit or a nano unit by adjusting the size of the minute droplet 411.

Therefore, the patterning control method according to another embodiment of the present invention forms the minute droplet 411 of the nano unit through the ejection probe 220, and stably ejects the minute droplet 411, thereby forming a solder bump of a minute size necessary for a packaging process and minutely controlling a pitch interval.

As described above, the patterning system according to the present invention forms a solder paste in a minute droplet and stably ejects the minute droplet by using a solder paste droplet ejection apparatus, thereby forming a bump of a minute size necessary for a packaging process and minutely controlling a pitch interval.

The patterning control method according to the present invention adjusts a solder paste in a minute droplet size and ejecting the minute droplet by using an ejection application voltage applied to a solder paste droplet ejection apparatus, thereby easily forming a solder pattern including a minute solder bump, etc.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A solder paste droplet ejection apparatus, comprising:
a nozzle cap forming an appearance and including a heating electric wire provided inside thereof;
a nozzle unit formed inside the nozzle cap, spaced apart from the nozzle cap, and surrounded by the nozzle cap;
an ejection probe formed inside the nozzle unit, spaced apart from the nozzle unit, and surrounded by the nozzle unit; and
a transfer unit formed in a top portion of the nozzle cap and used for a minute movement,
wherein a solder paste supplied in a space between the nozzle unit and the ejection probe is ejected in a droplet shape along the ejection probe.

2. The solder paste droplet ejection apparatus as set forth in claim 1, wherein the nozzle cap is formed in a tube shape having a width narrower in a lower direction, and forms a gas path that sprays an inert gas injected between the nozzle cap and the nozzle unit in a direction of an end portion.

3. The solder paste droplet ejection apparatus as set forth in claim 1, wherein the ejection probe is formed in a shape of a sharp needle in a direction of an end portion by using a metallic material, and is configured to protrude from an end portion through hole of the nozzle cap.

4. The solder paste droplet ejection apparatus as set forth in claim 1, wherein the nozzle unit includes a temperature detector for detecting a temperature of the solder paste inside thereof.

5. The solder paste droplet ejection apparatus as set forth in claim 1, wherein the transfer unit includes a piezo-actuator or a motor.

6. A patterning system comprising:
a stage holding a target and having an electric polarity;
a solder paste droplet ejection apparatus ejecting a solder paste to the target in a droplet shape;
a pressurizing unit supplying the solder paste from a storage unit of the solder paste to the solder paste droplet ejection apparatus;
a control unit performing a control on an ejection of the solder paste droplet;
a gas pumping unit connected to the control unit and supplying an inert gas to the solder paste droplet ejection apparatus; and
a display unit connected to the control unit and displaying control information on a nano-patterning operation using the solder paste droplet

7. The patterning system as set forth in claim 6, wherein the stage is connected to the control unit and has an electric polarity opposite to an electric polarity of the solder pasted droplet ejection apparatus.

8. The patterning system as set forth in claim 6, wherein the solder pasted droplet ejection apparatus includes:
a nozzle cap forming an appearance and including a heating electric wire provided inside thereof;
a nozzle unit formed inside the nozzle cap, spaced apart from the nozzle cap, and surrounded by the nozzle cap;
an ejection probe formed inside the nozzle unit, spaced apart from the nozzle unit, and surrounded by the nozzle unit; and
a transfer unit formed in a top portion of the nozzle cap and used for a minute movement,
wherein a solder paste supplied in a space between the nozzle unit and the ejection probe is heated by the heating electric wire and is ejected in a droplet shape along the ejection probe by the pressurizing unit.

9. The patterning system as set forth in claim 8, wherein the control unit controls a voltage applied to the ejection probe and controls a size of the solder paste droplet.

10. The patterning system as set forth in claim 9, wherein the control unit adjusts a pulse width of the voltage and applies the voltage.

11. The patterning system as set forth in claim 8, wherein the nozzle cap is formed in a tube shape having a width narrower in a lower direction, and forms a gas path that sprays an inert gas that is supplied from the gas pumping unit and is injected between the nozzle cap and the nozzle unit in a direction of an end portion.

12. The patterning system as set forth in claim 8, wherein the ejection probe is formed in a shape of a sharp needle in a direction of an end portion by using a metallic material, and is configured to protrude from an end portion through hole of the nozzle cap.

13. The patterning system as set forth in claim 8, wherein the nozzle unit includes a temperature detector for detecting a temperature of the solder paste inside thereof.

14. The patterning system as set forth in claim 8, wherein the transfer unit includes a piezo-actuator or a motor.

15. A patterning control method comprising:
preheating, by a control unit, a solder paste supplied to a solder paste droplet ejection apparatus to change the solder paste into a melting state;
ejecting, by the control unit, the melted solder paste onto a target in a minute droplet shape by using a voltage applied to the solder paste droplet ejection apparatus or an inert gas;
determining, by the control unit, whether a size of a pattern formed in the target by the ejected minute droplet is a desired size; and
according to a determination result that the size of the pattern is not the desired size, ejecting, by the control unit, the solder paste in the minute droplet shape again based on ejection conditions corrected on the solder paste droplet ejection apparatus.

16. The patterning control method as set forth in claim 15, wherein in the preheating, the control unit applies a voltage to a heating electric wire included in a nozzle cap forming an appearance of the solder paste droplet ejection apparatus to change the solder paste contained in the solder paste droplet ejection apparatus into the melting state.

17. The patterning control method as set forth in claim 15, wherein in the preheating, the control unit applies electric polarities to a stage holding the target and the solder paste droplet ejection apparatus to generate an electrostatic force between the target and the solder paste droplet ejection apparatus.

18. The patterning control method as set forth in claim 15, wherein in the ejecting of the melted solder paste onto the target in the minute droplet shape, the control unit sets an ejection application voltage applied to an ejection probe of the solder paste droplet ejection apparatus, a pulse waveform of the ejection application voltage, and a distance between the ejection probe and the target to eject the melted solder paste in the minute droplet shape.

19. The patterning control method as set forth in claim 18, wherein the ejection application voltage V is applied as a numerical value having a range of
$$h \sqrt{\frac{γ π}{{ɛ}_{0} d}} > V > \sqrt{\frac{γ kd}{2 {ɛ}_{0}}}$$
(γ: surface tension [N/m] of melted solder paste, ε0: dielectric permittivity [F/m] of vacuum, d: diameter of a sharp end portion of an ejection probe, h: distance between the ejection probe and a target, k: proportional constant).

20. The patterning control method as set forth in claim 15, wherein in the ejecting of the melted solder paste onto the target in the minute droplet shape, the minute droplet that is being formed is ejected by using a spray pressure of the inert gas injected into the solder paste droplet ejection apparatus.
